(19) United States
(12) Patent Application Publication
(10) Pub. No.: US 2010/0070590 A1
(43) Pub. Date: Mar. 18, 2010

(54) METHOD AND APPARATUS FOR ELECTRONIC COMMUNICATION

(76) Inventors: David Ryan Waldman, Santa Monica, CA (US); Michael Samuel Steuer, Los Angeles, CA (US); Gustavo De Greiff, Santa Monica, CA (US)

Correspondence Address: Michael Samuel Steuer, 11406 Missouri Ave., Los Angeles, CA, 90025, US

(21) Appl. No.: 12/212,677

(22) Filed: Sep. 18, 2008

(51) Int. Cl. G06F 15/16

(52) U.S. Cl. 709/206

(57) ABSTRACT

Methods and apparatus for communication by electronic mail have been provided, for example, communication by sending an electronic message to primary (To) and courtesy copy (Cc) recipients, and sending a message and comment to one or more blind copy (Bcc) recipients while withholding the comment from the primary (To) and courtesy copy (Cc) recipients. An embodiment of the invention is a method of communicating by electronic mail. The method comprises forming a message, acquiring a comment window, forming a comment within the comment window, selecting which of recipients is a first recipient and which of the recipients is a second recipient, sending a first electronic mail to the first recipient, and sending a second electronic mail to the second recipient. The first electronic mail comprises the message. The second electronic mail comprises the message and the comment. The comment is only sent in the second electronic mail. The invention enables, for example, private communications with selected recipients of an electronic communication without having to compose two separate communications. For example, a single composed email may be sent to all recipients, while a comment may be sent to only selected recipients.

### CROSS REFERENCE TO RELATED PATENT APPLICATIONS

The present application is related to the U.S. patent application identified as Attorney Docket No. 31908DSW-2 entitled “Address Replacement In Electronic Communication,” filed concurrently herewith, the disclosure of which is incorporated by reference herein.

The present application is related to the U.S. patent application identified as Attorney Docket No. 31908DSW-3 entitled “Receiving Email within an Email Thread,” filed concurrently herewith, the disclosure of which is incorporated by reference herein.

### FIELD OF THE INVENTION

This invention relates generally to the formation and transmission of electronic mail. More specifically, this invention relates providing additional information to selected recipients of the electronic mail.

### BACKGROUND OF THE INVENTION

Electronic mail, for example email and text messaging is used extensively for personal and business communication. Often, email messages are sent to more than one recipient, for example one or more primary (To) recipients, one or more courtesy copy (Cc) recipients, and one or more blind copy (Bcc) recipients. The recipients often have different levels of knowledge, different backgrounds, or different responsibilities with respect to the subject of the email. Consequently, it is often difficult, cumbersome or impossible to adequately communicate the subject to all recipients in a single email. This is especially true if it is desired to communicate additional specific items with selected recipients while withholding the additional specific items from other recipients. As a result, multiple emails or an email with associated phone calls to selected recipients often occur. Consequently, there is a need for a concise method of communication by electronic mail, particularly email, wherein, within a single composed electronic mail, a message is sent to all recipients, while only selected recipients are sent an additional comment.

### SUMMARY OF THE INVENTION

Principles of the invention provide, for example, methods and apparatus for communication by electronic mail, and communication by sending an electronic message to primary (To) and courtesy copy (Cc) recipients, and sending a message and comment to one or more blind copy (Bcc) recipients while withholding the comment from the primary (To) and courtesy copy (Cc) recipients.

For example, in accordance with one aspect of the invention, a method of communicating by electronic mail is provided. The method comprises forming a message, acquiring a comment window, forming a comment within the comment window, selecting which of recipients is a first recipient and which of the recipients is a second recipient, sending a first electronic mail to the first recipient, and sending a second electronic mail to the second recipient. The first electronic mail comprises the message. The second electronic mail comprises the message and the comment. The comment is only sent in the second electronic mail.

Advantages of the invention are, for example, enabling private communications with selected recipients of an electronic communication, without having to compose two separate communications. For example, a single composed email may be sent to all recipients, while a comment may be sent to only selected recipients.

These and other features, objects and advantages of the present invention will become apparent from the following detailed description of illustrative embodiments thereof, which is to be read in connection with the accompanying drawings.

### BRIEF DESCRIPTION OF THE DRAWINGS

FIG. 1 shows a method for communication by email, according to an exemplary embodiment of the invention.

FIG. 2 shows a method allowing a Bcc recipient to receive email within a first email thread or disallowing the Bcc recipient from receiving the email within the first email thread, according to an exemplary embodiment of the invention.

FIG. 3 shows a method allowing the Bcc recipient to reply to an email within a second email thread without disclosing the identity of the Bcc recipient, according to an exemplary embodiment of the invention.

FIG. 4 illustrates an email composer window, according to an exemplary embodiment of the invention.

FIG. 5 illustrates an alternate email composer window, according to an exemplary embodiment of the invention.

FIG. 6 illustrates a comment window, according to an exemplary embodiment of the invention.

FIG. 7 illustrates a first received email window, according to an exemplary embodiment of the invention.

FIG. 8 illustrates a second received email window, according to an exemplary embodiment of the invention.

FIG. 9 illustrates a comment option window, according to an exemplary embodiment of the invention.

FIG. 10 illustrates a computer system in accordance with which one or more components/steps of the techniques of the invention may be implemented, according to an exemplary embodiment of the invention.

FIG. 11 illustrates another alternate email composer window, according to an exemplary embodiment of the invention.

### DETAILED DESCRIPTION OF THE INVENTION

The term electronic mail, as used herein, refers to a communication, comprising text, by electronic means, for example, email and text messaging.

The term email server, as used herein, is a computer acting as a mail transfer agent (MTA), that is, the email server is running appropriate software, for example an MTA computer program. The email server along with the appropriate software transfers electronic mail messages from one computer to another. An MTA is also termed a mail transport agent, message transfer agent, simple mail transfer protocol (SMTP) daemon and extended or enhanced simple mail transfer protocol (ESMTP) daemon. The email server typically is coupled to a network, for example, the Web, Internet or an intranet, to facilitate email transfer.

The term client, as used herein, is a computing resource of a user, an originator, a receiver, or a responder to an email. The client is, for example, the computing resource on which the mail is composed, received, or responded to. The client is, for example, a computer, a laptop, a workstation, a text messaging device, personal digital assistant, a cellular phone, a portable Web access device, a television set top box, and a public email computing resource adapted to sending and receiving email. The client may be an on-site computing resource which is in possession of a user, a remote computing resource which is in communication with the on-site computing resource, or a combination of both. The remote computing resource is, for example, the computing resource of an on-line email provider, for example, providers of Yahoo mail and Hotmail. Communication between the on-site and remote computing resource is typically through the Internet, but could be through an intranet or other network. Clients can be associated with other entities besides the user. Unless specified otherwise, client refers to the client of the user.

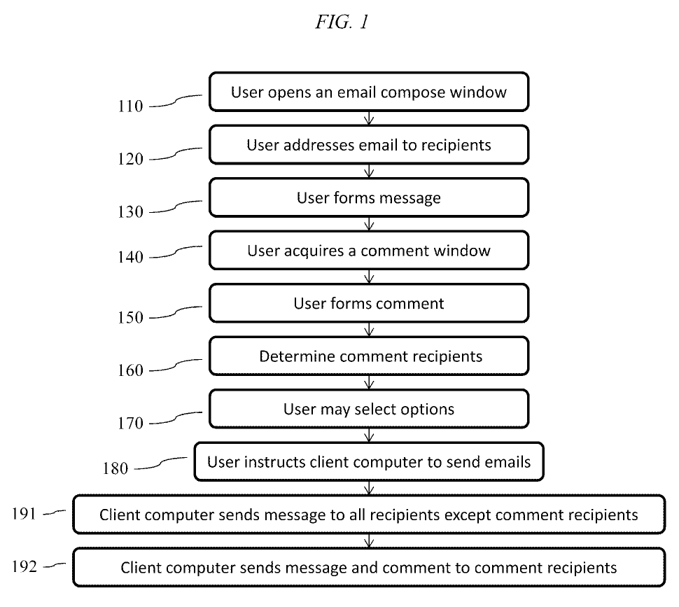

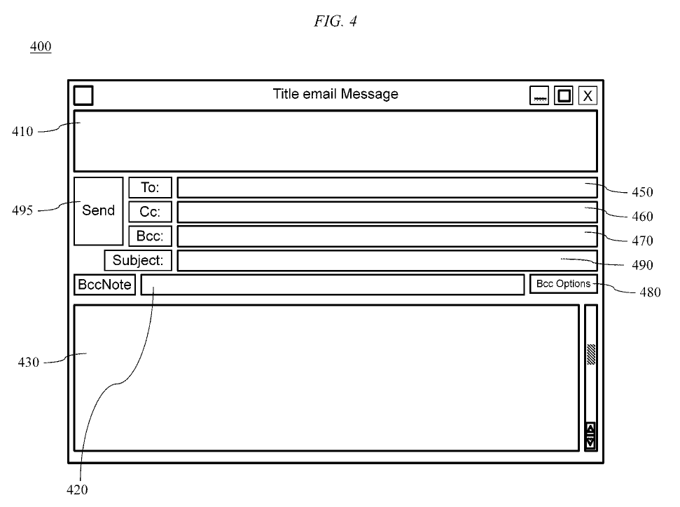

FIG. 1 shows a method 100 of communication by email according to an embodiment of the invention. FIG. 1 shows the steps of the method 100 occurring in an exemplary order. The invention is not so limited; the steps may occur in other orders. In the first step 110, the user opens a window in which to compose email. This window is termed the email composer window. The email composer window is a window opened within, as a plug-in of, or in association with, a program adapted to forming email, for example Microsoft Outlook. The program adapted to forming email may be a program separate from or viewed within an internet browser. Examples of email viewed within an internet browser are online email such as Yahoo mail and Hotmail. In alternate embodiments, the email composer window is a separate program, or part of a separate program, adapted to forming and sending email. FIG. 4 illustrates an email composer window 400 according to an embodiment of the invention.

In a second step 120 shown in FIG. 1, the user addresses the email to recipients of the email. The email addresses of direct (To) recipients are entered in a To recipient entry block 450 shown in FIG. 4. The email addresses of carbon or courtesy copy (Cc) recipients are entered in a Cc recipient entry block 460. The email addresses of blind carbon or blind courtesy copy (Bcc) recipients are entered in a Bcc recipient entry block 470, also termed the blind copy recipient address block.

The third step 130, shown in FIG. 1, is the user forming a message. The message is formed by entering the message within message entry block 430 shown in FIG. 4.

In the fourth step 140 shown in FIG. 1, the user accesses, acquires or opens a comment window. In this embodiment, the comment window is comment entry block 420 shown in FIG. 4. Comment entry block 420 may be presented upon opening the email composer window 400 or may be opened as an option within email composer window 400. For example, the Bcc option button 480 may be selected to open comment entry block 420.

In the fifth step 150, shown in FIG. 1, the user forms the comment by entering the comment within the comment entry window 420 shown in FIG. 4.

In the sixth step 160, shown in FIG. 1, the user determines the recipients of the comment. The default comment recipients are the Bcc recipients. Additional comment recipients can be selected by selecting the Bcc options button 480.

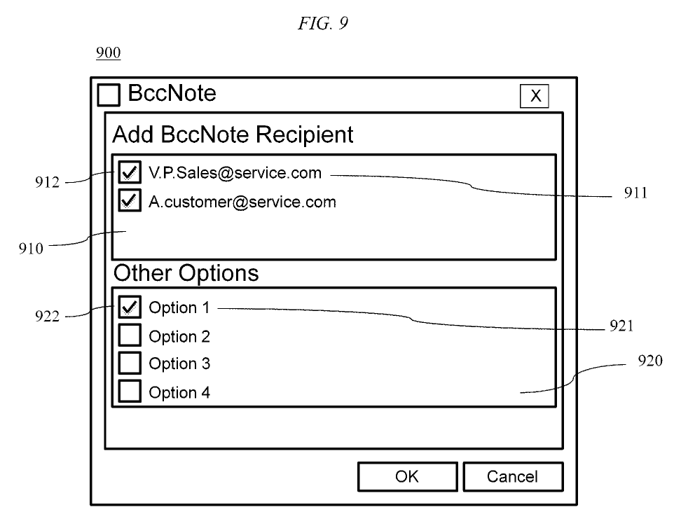

In the seventh step 170, shown in FIG. 1, the user selects options by selection of the Bcc Options button 480. Selection of the Bcc Options button 480 is typically performed by clicking on the Bcc Options button 480. In one embodiment, the Bcc Options button 480, when selected, provides comment option window 900 shown in FIG. 9. Comment option window 900 comprises an additional comment recipient block 910, labeled “Add Bcc Note Recipient” and an Other Option block 920. The additional comment recipient block 910 contains the addresses of the To and Cc recipients 911. Any To and Cc recipients may be selected to receive the comment by selecting their associated buttons 912. Selection is typically made by clicking on the associated button 912. Other options are indicated by an option name 921. Other options are selected by selecting their associated button 922, typically by clicking on their associated button 922. Other options are, for example, removing a Bcc recipient from the recipients to receive the comment, text control options, and spell check.

In the eighth step 180, shown in FIG. 1, the user instructs the client to send the email by selecting the Send button 495, shown in FIG. 4. Selection is typically made by clicking on the send button 495.

In the ninth step 191, shown in FIG. 1, the client sends the message to all recipients except comment recipients. A first email comprises the message.

In the tenth step 192, shown in FIG. 1, the client sends the message and the comment to comment recipients. A second email comprises the message and the comment.

The steps of the method 100 of communication by email are executed on the client. This includes the ninth step 191 and tenth step 192, the sending of the first and second emails. After the emails are sent by the client, the email infrastructure, typically comprising an email server and a network, for example the Web, Internet, or an intranet, assists in delivering the email to the recipients. The method 100 of communication by email, implemented on the client side, does not require a proprietary server infrastructure.

In an alternate embodiment, some of the steps of the method 100 of communication by email are executed, at least in part, by an email server. For example, step 180, the user instructing the client to send the emails, in the alternate embodiment, comprises, not only the user instructs the client, but the client instructs the email server to send the emails. In this embodiment, the first and second emails originate at the email server instead of the client. In the alternate embodiment, the email server receives, from the client, the message and the comment, as well as a first list of recipient, to receive the message only, and a second list of recipients, to receive the message with comment. The email server forms, at least partially, the first and the second emails. In this alternate embodiment, step 191, client sends message to all recipients except comment recipients, involves the email server sending the first email. In this alternate embodiment, step 192, client sends message and comment to comment recipients, involves the email server sending the second email.

In embodiments described above, the method 100 is for communication by email, where email is used in the narrow sense indicating use of an email transfer protocol, for example, SMTP or ESMTP. In an additional alternate embodiment, email is understood as electronic mail encompassing additional communications protocols, for example text messaging. In the additional alternate embodiment, text messaging is used. For example, text messaging that uses a short message service communications protocol or a multimedia messaging service protocol.

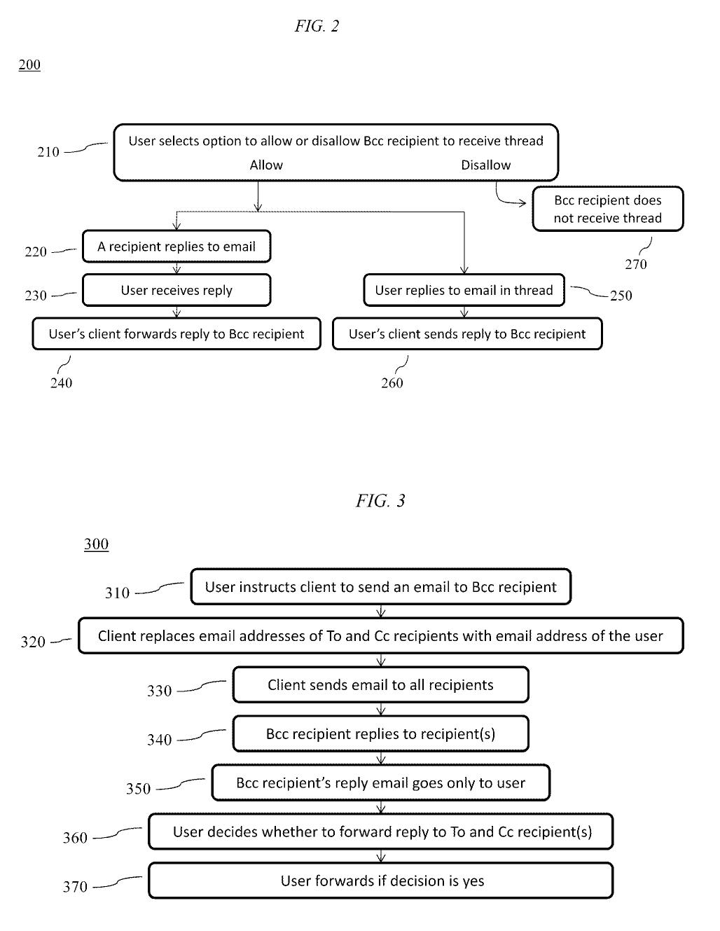

The identity of the Bcc recipient is not disclosed to the To and Cc recipients. Consequently, the To and Cc recipients can not normally include the Bcc recipient as a recipient to a response email. Thus, the Bcc recipient will normally not receive an email within an email thread, past the original email. A method 200 allowing a Bcc recipient to receive email within a first email thread or disallowing the Bcc recipient from receiving the email within the first email thread is shown in FIG. 2. In the method 200, it is not necessary for the Bcc recipient to become known to the To and Cc recipients, even if he is allowed to receive emails, other than an original email of the first email thread. In the method 100 of communicating by email, the original email is the second email. In the method 100 of communicating by email, the first email thread comprises the first email, the second email, any responses to the first or second email, and any responses to emails within the first email thread.

In the first step 210, the user selects to allow the Bcc recipient to receive emails within the first email thread or to disallow the Bcc recipient form receiving emails within the first email thread. The user is the originator of the original email. If the user allows the Bcc recipient to receive the emails of the first email thread, one of two paths is followed. The first path is for the Bcc recipient to receive a reply email from a To or Cc recipient, as shown in steps 220, 230 and 240. The second path is for the Bcc recipient to receive a reply email from the user, as shown in steps 250 and 260.

The first path includes the second step 220, a recipient replies to an email. The email replied to can be the original email or any email in the first email thread. The next step in the first path is the third step 230; the user receives the reply email. The user receiving the reply email comprises a client of the user receiving the reply email. In the last step of the first path, the fourth step 240, the client of the user forwards the reply email to the Bcc recipient.

The second path includes the fifth step 250, the user replies to an email in the first email thread. In the last step of the second path, the sixth step 260, the client of the user sends the reply of the user to the Bcc recipient.

If the decision in the first step 210, is that the Bcc recipient is disallowed from receiving email within the first email thread, then the seventh step 270 applies; the Bcc recipient does not receive any email within the first email thread, except the original email. In this embodiment, the decision to allow or disallow the Bcc recipient to receive emails within the first email thread is made once for any given first email thread. The client may be instructed to automatically forward replies to the Bcc recipient. In a different embodiment, the decision to allow or disallow the Bcc recipient to receive emails within the first email thread is made on an email by email basis. Thus, the user decides for each response email if the Bcc recipient is to receive the particular response email or not. The client of the user may be instructed to automatically forward replies to the Bcc recipient.

In many cases, it is desired that the identity of the Bcc recipient not be disclosed to the To and Cc recipients. The Bcc recipient responding to an email thread typically discloses that the Bcc recipient received the original email. FIG. 3 shows a method 300 allowing the Bcc recipient to reply to an email within a second email thread without disclosing the identity of the Bcc recipient. In the method 100 of communicating by email, the second email thread comprises the first email, the second email, any responses to the first or second email, and any responses to emails within the second email thread.

In the first step 310, the user sends a third email to the Bcc recipient by instructing the client of the user to send the third email. The first step 310 may be part of the method 100 of communication by email, for example, the eighth step 180 of method 100. In this case, the third email is the second email of the method 100 of communicating by email. Alternately the first step 310 of method 300 may not be part of method 100 of communication by email.

In the second step 320 of method 300, prior to the client of the user sending the third email, the client of the user replaces, within the third email, the email addresses of To and Cc recipients with the email address of the user. The client may retain the names of the To and Cc recipients within the third email, and associate the names of the To and Cc recipients with the email address of the user. Alternatively, the client may modify the names of the To and/or Cc recipients by replacing the names of the To and/or Cc recipients with, or adding to the names of the To and/or Cc recipients, text that is at least a portion of the email addresses of the To and/or Cc recipients. The modified names are associated with the email address of the user.

In the third step 330, the client sends the third email to the Bcc recipient. The client also send a fourth email to the To and Cc recipients. For example, the fourth email may be the first email of the method 100 of communicating by email. The third email sent to the Bcc recipient has the email addresses of the To and the Cc recipients replaced with the email address of the user. The fourth email sent to the To and Cc recipients does not have the email addresses of the To and the Cc recipients replaced with the email address of the user.

In the fourth step 340, the Bcc recipient replies to an email within the second email thread. The second email thread comprises the third and fourth emails, responses to the third and fourth emails, and responses to any email within the second email thread. The Bcc recipient sends the reply or response email to at least one of the To or Cc recipients or to all of the To and Cc recipients.

In the fifth step 350, the reply email of the Bcc recipient is sent to the user. It is not sent directly from the client of the Bcc recipient to any of the To and Cc recipients. The reply email is sent to the user instead of the To and Cc recipients because the email addresses of the To and Cc recipients were changed to the email address of the user in the second step 320. The user receives the reply email.

In the sixth step 360, the user decides to forward the reply email to the To and/or Cc recipients or not to forward the email to the To and/or Cc recipients. The user can selectively decide, that is, the user can decide to forward the reply email to one or more of the To and Cc recipients while not forwarding the reply email to one or more others of the To and Cc recipients. The decision can be a real time decision, that is, the user makes the decision for each reply email and for each To and Cc recipient. Alternately, the decision can be a premade decision, that is, the user has instructed the client of the user to automatically forward the reply email to all or selected ones of the To and Cc recipients.

The client of the user know the identity, and therefore the true email addresses of the To and Cc recipients, in one of two ways. One way is the association, within the reply email sent by the Bcc recipient, of the To and Cc recipients names with the email address of the user. In this case, the names of the To and Cc recipients were retained within the response email, but the email addresses associated with the names were changed to the email address of the user. In the other way, the names of the To and Cc recipients did not have to be retained within the reply email sent by the Bcc recipient. The client of the user associates the names of the To and Cc recipients with the fourth email, for example, by using text in the subject entry block of the received reply email, or by using text with the message block of the received reply email, for example, contents of the forwarded fourth message.

In the seventh step 370, the user forwards the reply email, according to the decision made in the sixth step 360, to all of or selected ones of the To and Cc recipients.

FIG. 4 illustrates an email composer window 400 according to an embodiment of the invention. The email composer window 400 comprises control and option block 410, comment entry block 420, message entry block 430, To recipient entry block 450, Cc recipient entry block 460, Bcc recipient entry block 470, Bcc option button 480, subject entry block 490, and send button 495. The control and option block 410 is a standard feature of most email composer windows. It typically comprises buttons to control the email or to select or set options of the email, for example, buttons associated with attachments, save to file, address book, email priority, insert signature, spell check, and fonts. The subject entry block 490 is where the subject of the email is, optionally, entered. The send button 495 is selected to send the email. Selecting the send button 495 is typically performed by clicking on the send button 495. Other components and functions of the email composer window 400 have been previously described.

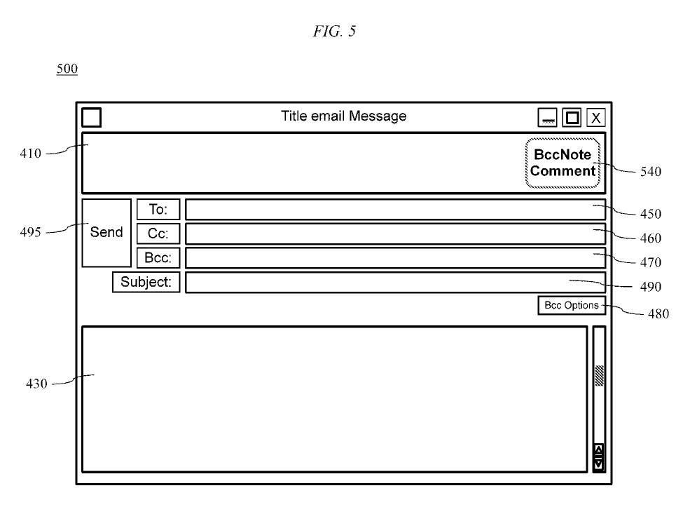

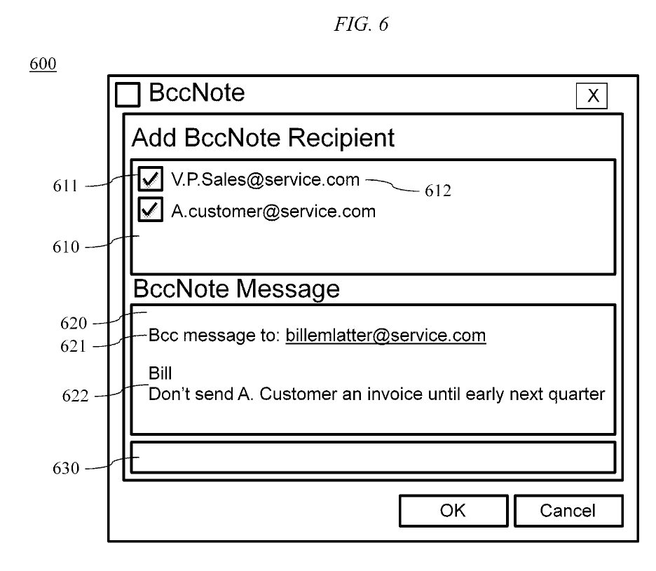

FIG. 5 shows an alternate email composer window 500 according to an alternate embodiment of the invention. As does email composer window 400, email composer window 500 comprises control and option block 410, message entry block 430, To recipient entry block 450, Cc recipient entry block 460, Bcc recipient entry block 470, Bcc option button 480, subject entry block 490, and send button 495, the functions of which are similar to the functions within the email composer window 400. The email composer window 500 does not include comment entry block 420. Instead of comment entry block 420, the email composer window 500 further comprises Bcc button (BCCNote Comment Button) 540. Selection the Bcc button opens a comment window, for example, the comment window 600 shown in FIG. 6. Selecting the Bcc comment button 540 is typically performed by clicking on the Bcc comment button 540.

FIG. 11 shows another alternate email composer window 1100 according to an alternate embodiment of the invention. As does email composer window 400, email composer window 1100 comprises control and option block 410, message entry block 430, To recipient entry block 450, Cc recipient entry block 460, Bcc recipient entry block 470, Bcc option button 480, subject entry block 490, and send button 495, the functions of which are similar to the functions within the email composer window 400. The email composer window 1100 does not include comment entry block 420. Instead of comment entry block 420, the email composer window 1100 further comprises an alternate comment entry block 1120. The comment is entered into the alternate comment entry block 1120 is a manner similar to how the comment is entered into comment entry clock 420. The email composer window 1100 further comprises a comment recipient address block 1130 comprising Bcc recipient addresses 1131, and a check box 1132 for selecting or deselecting the Bcc recipients for receiving the comment. Optionally, the comment recipient address block 1130 may further comprise To recipient address and/or Cc recipient addresses, along with associated check boxes 1132. Checking a check box 1132 selects the associated recipient to receive the comment. Deselecting the associated check box 1132 deselects the associated recipient from receiving the comment. Additionally, or in place of the BCC, To and/or Cc recipient addresses may be a pointer to the recipient address (not shown), for example, the name of the recipient. The comment entry block 1120 and the comment recipient address block 1130 may be hidden or closed within the email composer window 1100. If not opened, the alternate comment entry block 1120 may be opened by indicating within the email composer window 1100 that the comment window is requested. The indicating is typically done by selecting a button within the email composer window 1100. Likewise, the alternate comment entry block 1120 may be closed by indicating, within the email composer window 1100, that the alternate comment entry block 1120 is to be closed or hidden. The alternate comment window 1100 is opened or formed in response to the indication that the alternate comment window is requested. The alternate comment window 1100 is closed or hidden in response to the indication that the alternate comment window is to be closed.

FIG. 6 shows the comment window 600 according to an embodiment of the invention. Comment window 600 comprises comment recipient block 610, comment entry block 620, and options-control block 630. Comment recipient block 610 comprises the names of the recipients 612 optionally expressed as email addresses of the recipients, and recipient buttons 611 associated with each comment recipients 611. Comment entry block 620 is where the comment is entered. The comment will be sent along with the message in an email to the comment recipients. Comment entry block 620 comprises a comment 622, and optionally the names or email addresses 621 of the comment recipients, for example the Bcc recipients. Options-control block 630 comprises buttons for options and/or controls, for example, text font, text size, text color, highlighting, spell check, and paragraph controls. The comment recipients are typically the Bcc recipients; however additional recipients that are To or Cc recipients can be selected. Selection of To and Cc recipients is done by clicking on the recipient button 611 associated with the recipient name 612. Bcc recipients can be deselected by clicking on the recipient button 611 associated with the Bcc recipient name 612 that is to be deselected. A deselected Bcc recipient can be selected by clicking on the recipient button 611 associated with the Bcc recipient name 612 that is to be selected. A selected To and Cc recipient can be deselected by clicking on the recipient button 611 associated with the To or Cc recipient name 612 that is to be deselected. Comment window 600 is an alternate way to enter the comment from comment entry block 420 (FIG. 4).

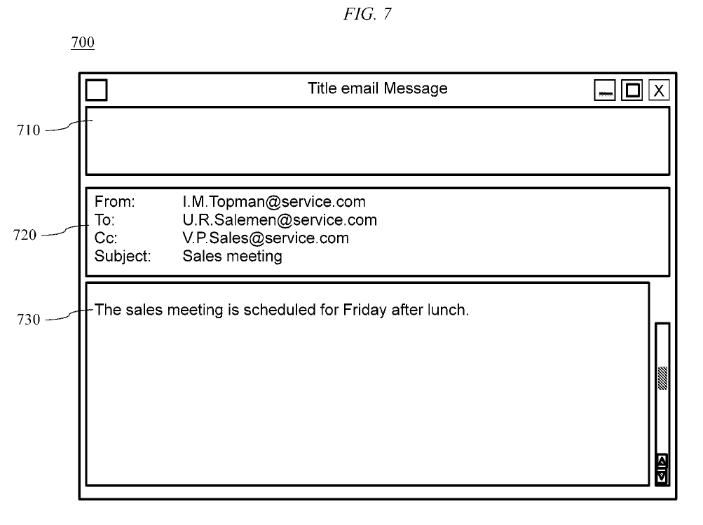

FIG. 7 shows a first received email 700 according to an embodiment of the invention. The first received email corresponds to the first email that was sent. The first email was sent to the recipients who are not the comment recipients. The first received email 700 comprises a received email option-control block 710, a received email information block 720, and a received email message block 730. The received email option-control block 710 comprised option and control buttons, for example, buttons for replying, forwarding, move to folder, other actions, junk email, email control and finding email. The received email information block 720 typically indicates who sent the email, the To and Cc recipients, and the subject of the email. The received email message block 730 displays the message. Windows with alternate forms can also display the first received email. In any case, the displayed first received email will comprise at least the message displayed, and it will not display the comment.

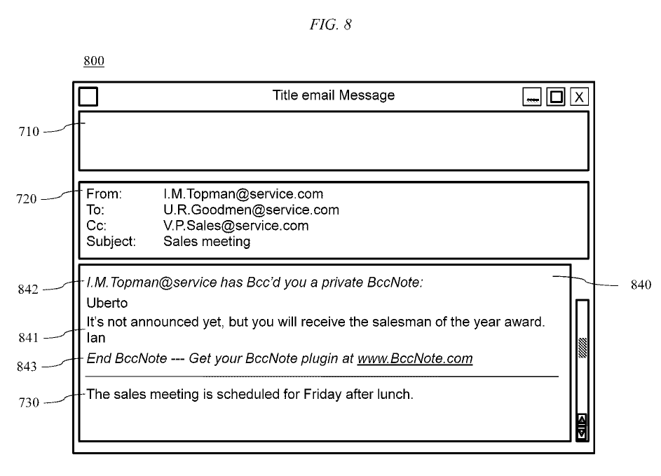

FIG. 8 shows a second received email 800 according to an embodiment of the invention. The second received email corresponds to the second email that was sent. The second email was sent to the comment recipients. The second received email 800 comprises the received email option-control block 710, the received email information block 720, the received email message block 730, and a second received email comment block 840. The received email option-control block 710 comprised option and control buttons, for example, buttons for replying, forwarding, move to folder, other actions, junk email, email control and finding email. The received email information block 720 typically indicates who sent the email, the To and Cc recipients, and the subject of the email. The received email message block 730 displays the message. The second received email comment block 840 displays the comment 841. The second received email comment block 840 optionally displays a note 842 informing the comment recipient that he has received a comment, and a promotion 843. The promotion 843 is, for example, a promotion for the program or resource enabling the comment or the method 100 for communication by email. Alternately or in addition, the promotion 843 may be an advertisement. Window with alternate forms can also display the second received email. In any case, the displayed second received email will comprise at least the message displayed and the comment displayed.

FIG. 9 shows comment option window 900 according to an embodiment of the invention. Comment option window 900 comprises additional comment recipient block 910, labeled “Add Bcc Note Recipient” and another option block 920. The components and function of comment option window 900 has been previously described.

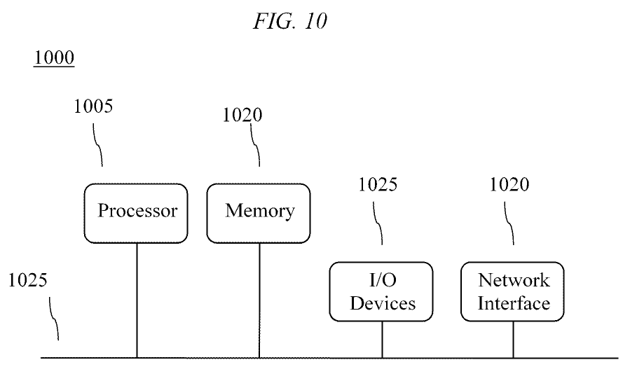

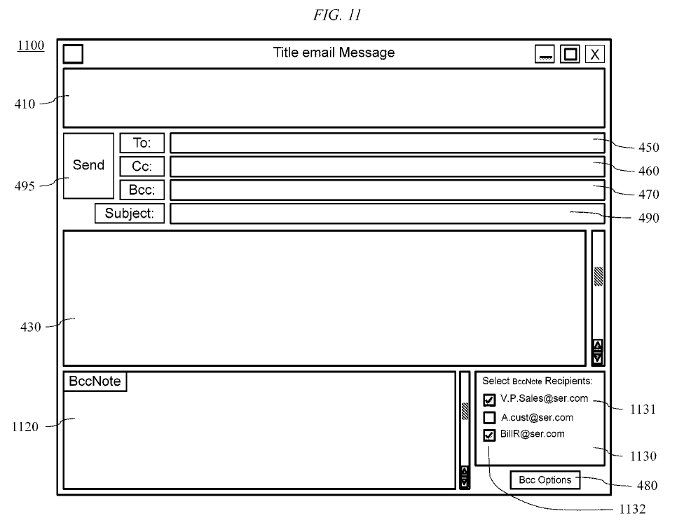

FIG. 10 illustrates a computer system in accordance with which one or more components/steps of the techniques of the invention may be implemented, for example, the components/steps depicted in FIGS. 1-9. It is to be further understood that the individual components may be implemented on one or more such computer system. In the case of an implementation on a distributed computing system, the individual computer systems and/or devices may be connected via a suitable network, e.g., cellular phone network, the Internet, the World Wide Web, a private network, or a local network. The invention is not limited to any particular network.

The computer system shown in FIG. 10 may represent one or more servers, mobile or stationary computing devices, one or more other processing devices, or one or more memory devices capable of providing all or portions of the functions described herein. The computer system may generally include a processor 1005, memory 1010, input/output (I/O) devices 1015, and network interface 1020, coupled via a computer bus 1025.

It is to be appreciated that the term “processor” as used herein is intended to include any processing device, such as, for example, one that includes a central processing unit (CPU) and/or other processing circuitry. It is also to be understood that the term “processor” may refer to more than one processing device and that various elements associated with a processing device may be shared by other processing devices. Processors may include memory, for example, cache memory.

The term “memory” as used herein includes memory embedded within a processor, an I/O device, and a network interface, for example, a cache memory within a processor. Memory may be embedded within an integrated circuit having other functions, for example, a processor chip with embedded memory. Alternately, memory may be within an integrated circuit functioning mainly as a memory integrated circuit. The term “memory” as used herein is intended to also include memory associated with a processor or CPU, such as, for example, random access memory (RAM), read only memory (ROM), a fixed memory device (e.g., hard disk drive), a removable memory device (e.g., diskette, compact disk, digital video disk or flash memory module), flash memory, non-volatile memory, etc. The memory may be considered a computer readable storage medium. At least one memory contains one or more software programs according to embodiments the invention, for example, one or more software programs formed to implement the method 100 for communication by email, formed to provide, the method 200 allowing a Bcc recipient to receive the email thread or disallowing the Bcc recipient from receiving the email thread, the method 300 allowing the Bcc recipient to reply to an email within the thread without disclosing identity of the Bcc recipient, forming an email composer window 400 or an alternate email composer window 500 according to an embodiment of the invention, forming the comment window 600, forming a window for a second received email 800 according to an embodiment of the invention, and forming comment option window 900.

In addition, the phrase “input/output devices” or “I/O devices” as used herein is intended to include, for example, one or more input devices (e.g., keyboard, mouse, camera, etc.) for entering data to the processing unit, and/or one or more output devices (e.g., display, etc.) for presenting results associated with the processing unit.

Still further, the phrase “network interface” as used herein is intended to include, for example, one or more transceivers to permit the computer system to communicate with another computer system via an appropriate communications protocol.

Although illustrative embodiments of the invention have been described herein with reference to the accompanying drawings, it is to be understood that the invention is not limited to those precise embodiments, and that various other changes and modifications may be made therein by one skilled in the art without departing from the scope of the appended claims.

Embodiments of the invention illustrate the invention adapted for use with email. The invention is not so limited. Embodiments of the invention are adapted for use with electronic mail, for example test messaging.

What is claimed is:

1. A method of communication by electronic mail, wherein the method comprises the steps of:
forming a message;
acquiring a comment window;
forming a comment within the comment window;
selecting which of recipients is a first recipient and which of the recipients is a second recipient;
sending a first electronic mail to the first recipient, wherein the first electronic mail comprises the message; and
sending a second electronic mail to the second recipient, wherein the second electronic mail comprises the message and the comment, and wherein the comment is only sent in the second electronic mail.

2. The method of claim 1 further comprising the steps of:
opening an electronic mail compose window, wherein the electronic mail compose window is adapted to the formation of a composed electronic mail, and wherein the composed electronic mail comprises the message;
addressing the composed electronic mail to the recipients; and
instructing the composed electronic mail to be sent.

3. The method of claim 1, wherein the steps of sending the first electronic mail and sending the second electronic mail are performed by a client of a sender, wherein the sender performs the steps of the forming of the message, and the forming of the comment.

4. The method of claim 3, wherein the client is at least one of a laptop, a workstation, a computer, a text messaging device, a cellular phone, a personal digital assistant, a portable web access device, a television set top box, and a public e-mail computing resource adapted to sending and receiving an electronic mail message, and wherein the client is at least one of a user computing resource in possession of an electronic mail user, and a remote computing resource of an on-line email provider.

5. The method of claim 1, wherein the first electronic mail comprises a first text message, and the second electronic mail comprises a second text message, and wherein the first text message and the second text message are sent using at least one of a short message service communications protocol and a multimedia messaging service protocol.

6. The method of claim 2, wherein a sender performs the steps of the addressing of the composed electronic mail, the forming of the message, the forming of the comment, the selecting which of the recipients is the first recipient and which of the recipients is the second recipient, and the instructing for the composed electronic mail to be sent.

7. The method of claim 1, wherein the step of selecting which of the recipients is the first recipient and which of the recipients is the second recipient comprises entering an electronic mail address of the second recipient in a blind copy recipient address block.

8. The method of claim 2, wherein the step of the acquiring of the comment window comprises the steps of:
indicating within the electronic mail composer window that the comment window is requested; and
forming the comment window in response to the indication that the comment window is requested, wherein the comment window comprises a first comment sub-window adapted to the step of the selecting which of the recipients is the first recipient and which of the recipients is the second recipient, and a second comment sub-window adapted to the step of the forming of the comment.

9. The method of claim 2, wherein the step of the acquiring of the comment window comprises the step of:
acquiring a comment block available and apparent within the electronic mail composer window.

10. The method of claim 1 further comprising the steps of:
forming a third electronic mail, wherein the step of the forming of the third electronic mail comprises the step of addressing the third electronic mail to a third recipient having a third recipient name and a third recipient address;
sending the third electronic mail to a fourth recipient in place of the third recipient, wherein the fourth recipient has a fourth recipient address, wherein the third electronic mail comprises the fourth recipient address in place of the third recipient address, and at least one of the third recipient name and text including at least a portion of the third recipient address; and
forwarding the third electronic mail, by the fourth recipient, to the third recipient.

11. The method of claim 10, wherein a sender, having a sender address, causes the step of the sending of the second electronic mail to the second recipient, wherein the third electronic mail comprises a reply to the second electronic mail, wherein the third recipient is the first recipient, wherein the fourth recipient is the sender, wherein the fourth recipient address is the sender address, and wherein the second recipient performs the step of the forming of the third electronic mail.

12. The method of claim 10, wherein a client of the fourth recipient is adapted to perform the step of the forwarding of the third electronic email.

13. The method of claim 1 further comprising the steps of:
the first recipient sending a first reply electronic mail, wherein a sender, having a sender address, causes the step of the sending of the first electronic mail to the first recipient, wherein a sender client is adapted to the sending of the first electronic mail;
the sender client receiving the first reply electronic mail; and
the sender client forwarding the first reply electronic mail to the second recipient, wherein the first reply electronic mail is in reply to at least one of the first electronic mail and a third electronic mail, and wherein an electronic mail thread comprises the first electronic mail and the third electronic mail.

14. The method of claim 13 further comprising the step of:
the sender sending a second reply electronic mail to the second recipient, wherein the second reply electronic mail is in reply to at least one of the first electronic mail and the third electronic mail.

15. An article of manufacture for forming a communication by electronic mail, the article comprising a computer readable storage medium having one or more programs embodied therewith, wherein the one or more programs, when executed by a computer, perform steps of:
forming a message;
acquiring a comment window;
forming a comment within the comment window;
selecting which of recipients is a first recipient and which of the recipients is a second recipient;
sending a first electronic mail to the first recipient, wherein the first electronic mail comprises the message; and
sending a second electronic mail to the second recipient, wherein the second electronic mail comprises the message and the comment, and wherein the comment is only sent in the second electronic mail.

16. The article of manufacture of claim 15, wherein the one or more programs, when executed by the computer, further perform steps of:
opening an electronic mail compose window, wherein the electronic mail compose window is adapted to the formation of a composed electronic mail, and wherein the composed electronic mail comprises the message;
addressing the composed electronic mail to the recipients; and
instructing the composed electronic mail to be sent.

17. The article of manufacture of claim 15, wherein the one or more programs, when executed by the computer, further perform steps of:
forming a third electronic mail, wherein the step of the forming of the third electronic mail comprises the step of addressing the third electronic mail to a third recipient having a third recipient name and a third recipient address;
sending the third electronic mail to a fourth recipient in place of the third recipient, wherein the fourth recipient has a fourth recipient address, wherein the third electronic mail comprises the third recipients name, and the fourth recipient address in place of the third recipient address, and wherein the third recipient address is withheld from the third electronic mail; and
forwarding the third electronic mail, by the fourth recipient, to the third recipient.

18. The article of manufacture of claim 15, wherein the one or more programs, when executed by the computer, further perform steps of:
the first recipient sending a first reply electronic mail, wherein a sender, having a sender address, causes the step of the sending of the first electronic mail to the first recipient, wherein a s client is adapted to the sending of the first electronic mail;
the sender client receiving the first reply electronic mail; and
the sender client forwarding the first reply electronic mail to the second recipient, wherein the first reply electronic mail is in reply to at least one of the first electronic mail and a third electronic mail, and wherein an electronic mail thread comprises the first electronic mail and the third electronic mail.

19. Apparatus for forming a communication by electronic mail, the apparatus comprising:
a memory;
a processor coupled to the memory and configured to:
form a message;
acquire a comment window;
form a comment within the comment window;
select which of recipients is a first recipient and which of the recipients is a second recipient;
send a first electronic mail to the first recipient, wherein the first electronic mail comprises the message; and
send a second electronic mail to the second recipient, wherein the second electronic mail comprises the message and the comment, and wherein the comment is only sent in the second electronic mail.

20. The apparatus of claim 19, wherein the method for forming the communication further comprises the steps of:
opening an electronic mail compose window, wherein the electronic mail compose window is adapted to the formation of a composed electronic mail, and wherein the composed electronic mail comprises the message;
addressing the composed electronic mail to the recipients; and
instructing the composed electronic mail to be sent.
